(19) United States
(12) Patent Application Publication
(10) Pub. No.: US 2010/0013849 A1
(43) Pub. Date: Jan. 21, 2010

(54) APPARATUS AND METHOD FOR CONTROLLING BRIGHTNESS OF BACKLIGHT UNIT

(75) Inventors: Jeong-Seok YUN, Seoul (KR); Yong-Hyeok KIM, Yongin-si (KR); Hyung-Jin PARK, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/500,244

(22) Filed: Jul. 9, 2009

(30) Foreign Application Priority Data
Jul. 17, 2008 (KR) 10-2008-0069438

(51) Int. Cl. G09G 5/02; G09G 5/00; H05B 39/04

(52) U.S. Cl. 345/589; 345/207; 315/150

(57) ABSTRACT

An apparatus and method for controlling brightness of a backlight unit in an electronic apparatus is provided. The apparatus includes a solar light generator and a controller. The solar light generator generates a current in proportion to an amount of light. The controller determines the brightness of the backlight unit according to the current. Therefore, a contradiction that an illuminance sensor which causes another current consumption is used in order to control the backlight unit according to an ambient light amount of an electronic apparatus may be resolved.

### PRIORITY

This application claims the benefit under 35 U.S.C. §119(a) of a Korean patent application filed in the Korean Intellectual Property Office on Jul. 17, 2008 and assigned Serial No. 10-2008-0069438, the entire disclosure of which is hereby incorporated by reference.

### BACKGROUND OF THE INVENTION

1. Field of the Invention

The present invention relates to an apparatus and a method for controlling brightness of a backlight unit in an electronic apparatus. More particularly, the present invention relates to an apparatus and a method that controls the brightness of a backlight unit to reduce current consumption of an electronic apparatus.

2. Description of the Related Art

Generally, a ‘backlight unit’ is used as a light source to increase user's readability of a display device and a keypad of an electronic apparatus. Examples of the electronic apparatus include a cellular phone, a TeleVision (TV), a computer, and the like.

More particularly, a Liquid Crystal Display (LCD) device emits light using a backlight unit without emitting light by itself. The quality of the backlight unit affects image quality and color reproduction.

Furthermore, in response to a trend for an electronic apparatus to have a slim profile and a reduced weight, there is an interest in minimizing current consumption. One of the components being investigated to reduce current consumption is the backlight unit.

Some electronic apparatuses measure ambient light using an illuminance sensor in order to control an amount of light (or brightness) of a backlight unit, and controls the brightness of the backlight unit using measured data.

FIG. 1 is a flowchart illustrating a conventional method of controlling an amount of light from a backlight unit in an electronic apparatus that uses an illuminance sensor.

Referring to FIG. 1, the electronic apparatus supplies power to an illuminance sensor in order to measure an amount of external light using the illuminance sensor of an illuminance sensor unit in step 11. At this point, the electronic apparatus may reduce current consumption by supplying power every preset time period to turn on/off the illuminance sensor.

After that, the electronic apparatus compares an amount of external light detected by the illuminance sensor unit with a threshold stored in advance in a storing unit in step 12. When the detected light amount is less than the threshold, the electronic apparatus increases the brightness of backlight units provided to a keypad Light Emitting Diode (LED) and an LCD in step 13. In contrast, when the detected light amount is greater than the threshold, the electronic apparatus decreases the brightness of the backlight units in step 14.

According to the method of controlling an amount of light from a backlight unit in an electronic apparatus using the illuminance sensor unit, the illuminance sensor unit itself consumes power. As described above, to minimize power consumed by the sensor, the conventional method of controlling an amount of light from a backlight unit controls an illuminance sensor by supplying power periodically. However, the conventional method of controlling an amount of light from a backlight unit may not immediately control a light amount of the backlight unit in the case where an amount of external light rapidly changes within a period. For example, in the case where the electronic apparatus suddenly moves to a relatively bright or dark place, it may take a long time to change the brightness of the backlight unit to an appropriate level.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for controlling the brightness of a backlight unit in order to reduce power consumption of a mobile terminal.

Another aspect of the present invention is to provide an apparatus and a method for controlling the brightness of a backlight unit using a solar light generation unit that does not require separate current supply.

In accordance with an aspect of the present invention, an apparatus for controlling brightness of a backlight unit is provided. The apparatus includes a solar light generator for generating current in proportion to an amount of light, and a controller for determining the brightness of the backlight unit according to the current.

In accordance with another aspect of the present invention, a method for controlling brightness of a backlight unit in an electronic apparatus having a solar light generator is provided. The method includes detecting a current generated by the solar light generator according to an external amount of light incident to the apparatus, comparing an intensity of the determined current with a threshold, and controlling the brightness of the backlight unit based on the compared value.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a flowchart illustrating a conventional method of controlling an amount of light from a backlight in an electronic apparatus that uses an illuminance sensor;

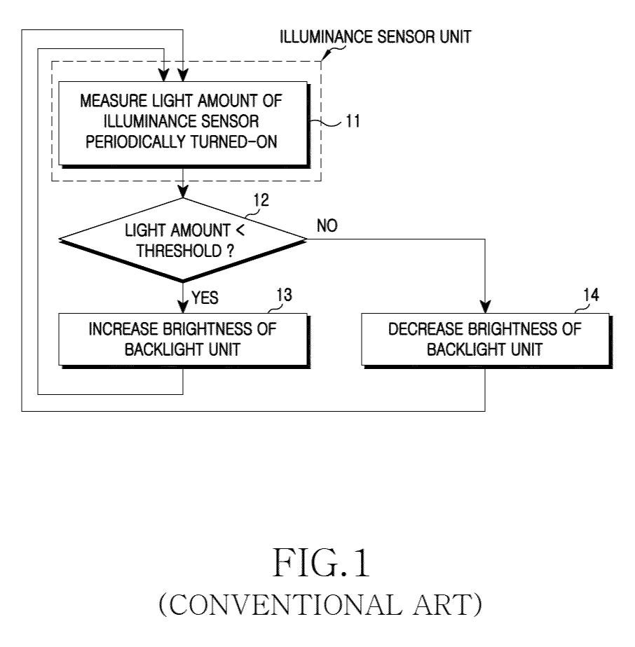

FIG. 2 is a block diagram illustrating a backlight module according to an exemplary embodiment of the present invention; and

FIG. 3 is a flowchart illustrating a method of controlling brightness of a backlight module according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawing is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following descriptions and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

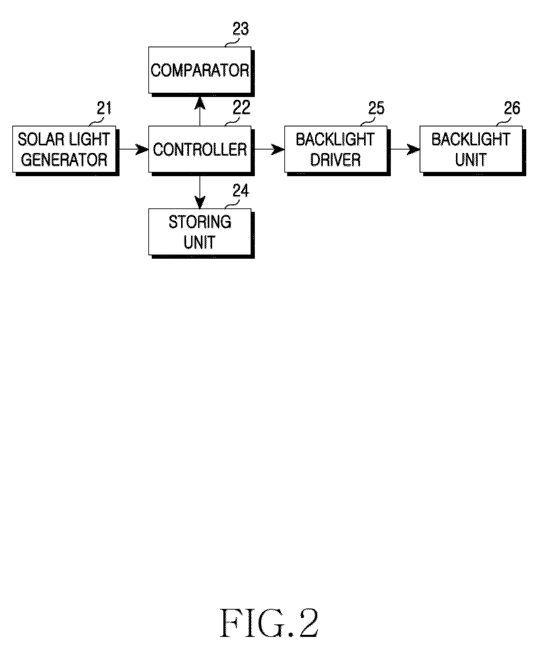

FIG. 2 is a block diagram illustrating a backlight module according to an exemplary embodiment of the present invention.

Referring to FIG. 2, the backlight module includes a solar light generator 21, a controller 22, a comparator 23, a storing unit 24, a backlight driver 25, and a backlight unit 26. The backlight module utilizes a current change in proportion to an ambient light amount (or brightness) and may control brightness of the backlight unit.

The solar light generator (or generating unit) 21 converts condensed light energy into a current which is electrical energy. The intensity of the current is proportional to an amount of ambient light. In addition, since the solar light generator 21 operates by itself by receiving light, no separate power source is required. Therefore, the brightness of the backlight unit 26 may be controlled based on a current change generated at the solar light generator 21.

The solar light generator 21 includes a panel attaching a solar cell (optical cell) thereon, and converts light energy into electrical energy. Generally, the solar cell has a structure in which a current flows from a rear electrode to a front electrode depending on an amount of light entering the front electrode. The solar cell is classified into a solar cell formed of a silicon semiconductor and a solar cell formed of a compound semiconductor. In an exemplary implementation, a thin film solar cell may be used as the solar light generator 21.

The solar cell may be installed such that the solar cell is exposed to the outside of an electronic apparatus to condense external light. More particularly, as an exemplary implementation, the solar cell may be installed adjacent to an LCD and a keypad that use backlight units.

The backlight unit 26 serves as a light source of the electronic apparatus. The backlight unit 26 may be one of a Cold Cathode Fluorescent Lamp (CCFL), an External Electrode Fluorescent Lamp (EEFL), an LED, a Flat Fluorescent Lamp (FFL), and the like.

The controller 22 controls overall operations of the backlight module. The controller 22 transfers a control message for controlling the backlight unit 26 to a backlight driver 24 based on the intensity of a current generated at the solar light generator 21 in proportion to an external light amount.

The backlight driver 25 serves as an interface between the controller 22 and a program related to a backlight control, and the backlight unit 26. The backlight driver 25 determines the brightness and on/off state of the backlight unit 26 according to a control message transferred from the controller 22.

The comparator 23 compares the intensity of current detected by the solar light generator 21 with a threshold stored in advance in the storing unit 24.

The backlight driver 25 and the comparator 23 may be included in the controller 22.

According to an exemplary embodiment of the present invention, when the intensity of the detected current is less than the threshold, the controller 22 increases the brightness of the backlight unit 26 provided to the LCD and the keypad of the electronic apparatus. In contrast, when the detected current is greater than the threshold, the controller 22 decreases the brightness of the backlight unit 26. The degree (or value) of brightness increased or decreased may be subdivided corresponding to a difference between the intensity of the detected current and the threshold. Information of the subdivided brightness value is stored in the storing unit 24.

In an exemplary implementation, the controller 22 quantizes a current changing in an analog fashion with respect to time at the solar light generator 21 in the form of digital data for each section of a preset time because when a current changes minutely depending on a minute change of an amount of light at the solar light generator 21 is used to control the backlight unit 26, the brightness of the backlight unit 26 often changes and may cause confusion to a user. The controller 22 determines one of illuminance levels divided corresponding to thresholds of specific current values to which the quantized current value belongs. That is, the controller 22 determines the illuminance level by comparing the quantized current value with the threshold. Here, the illuminance level serves as an index representing an amount of external light, and information of which is stored in the storing unit 24. For example, the illuminance level may be classified into ‘dark’, ‘normal’, ‘bright’, and ‘very bright’. At this point, the controller 22 may control the brightness of the backlight unit corresponding to the determined illuminance level. For example, if the quantized current value belongs to a level ‘dark’, the controller 22 determines that an external light amount is insufficient and increases brightness of the backlight unit 26 according to a prescribed scenario.

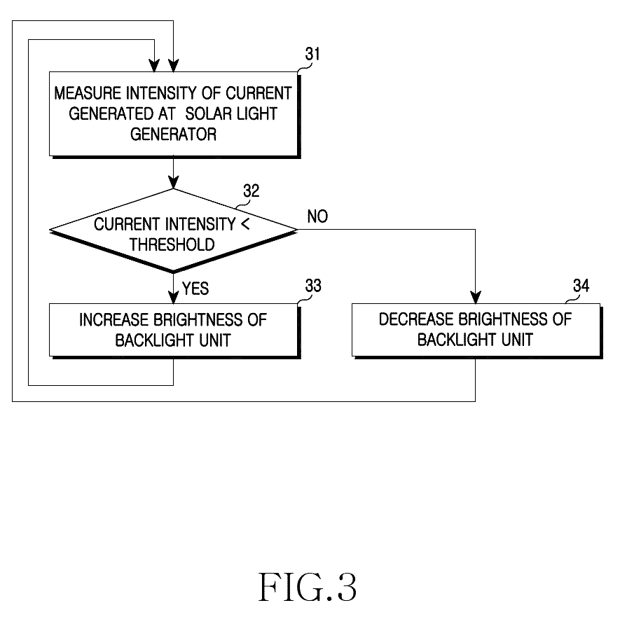

FIG. 3 is a flowchart illustrating a method of controlling a light amount of a backlight module according to an exemplary embodiment of the present invention.

Referring to FIG. 3, in step 31, the controller 22 detects the intensity of current generated at the solar light generator 21 in proportion to an external light amount.

In step 32, the controller 22 compares the intensity of the current detected in step 31 with a threshold stored in advance in the storing unit 24.

When the intensity of the detected current is less than the threshold, the controller 22 increases the brightness of the backlight unit 26 in step 33. In contrast, if the intensity of the detected current is greater than the threshold, the controller 22 decreases the brightness of the backlight unit 26 in step 34. The degree of increasing or decreasing the brightness of the backlight unit 26 may be subdivided corresponding to a difference between the detected current and the threshold.

More particularly, as described in FIG. 2, the controller 22 determines an illuminance level of the outside by comparing the quantized value of the detected current with the threshold. The controller 22 controls the brightness of the backlight unit 26 corresponding to the determined illuminance level according to a backlight brightness control scenario. By doing so, the controller 22 may reduce confusion where the brightness of the backlight unit 26 often changes according to a small change of an amount of external light. For the degree of increasing or decreasing the brightness of the backlight unit 26, the controller 22 refers to the backlight brightness control scenario stored in the storing unit 24 after determining the illuminance level.

Since an apparatus and a method for controlling the brightness of the backlight unit according to an exemplary embodiment of the present invention do not use an illuminance sensor requiring operating power, current consumption of a relevant apparatus having the backlight unit may be reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for controlling brightness of a backlight unit, the apparatus comprising:
a solar light generator for generating current in proportion to an amount of light; and
a controller for determining the brightness of the backlight unit according to the current generated by the solar light generator.

2. The apparatus of claim 1, wherein when an intensity of the current is less than a threshold, the controller increases the brightness of the backlight unit, and when the intensity of the current is greater than the threshold, the controller decreases the brightness of the backlight unit.

3. The apparatus of claim 2, wherein a degree of the increasing or the decreasing, at the controller, of the brightness of the backlight unit is subdivided based on a value of comparing the threshold with the intensity of a detected current.

4. The apparatus of claim 1, wherein the controller determines an external illuminance level by quantizing the current and comparing the quantized current with a threshold, and determines the brightness of the backlight unit corresponding to the determined illuminance level.

5. The apparatus of claim 1, wherein the solar light generator comprises a thin film panel with a solar cell disposed thereon.

6. The apparatus of claim 1, wherein the solar light generator is installed such that the solar light generator is exposed to ambient light and installed adjacent to an element that uses light from the backlight unit.

7. The apparatus of claim 6, wherein the element which uses the light from the backlight unit comprises at least one of a Liquid Crystal Display (LCD) and a keypad.

8. The apparatus of claim 1, wherein the backlight unit comprises at least one of a Cold Cathode Fluorescent Lamp (CCFL), an External Electrode Fluorescent Lamp (EEFL), a Light Emitting Diode (LED), and a Flat Fluorescent Lamp (FFL).

9. A method for controlling brightness of a backlight unit in an electronic apparatus having a solar light generator, the method comprising:
detecting a current generated by the solar light generator according to an amount of external light incident to the apparatus;
comparing an intensity of the detected current with a threshold; and
controlling the brightness of the backlight unit based on the compared value.

10. The method of claim 9, wherein when an intensity of the current is less than a threshold, the brightness of the backlight unit is increased, and when the intensity of the current is greater than the threshold, the brightness of the backlight unit is decreased.

11. The method of claim 10, wherein a degree of the increasing or the decreasing of the brightness of the backlight unit is subdivided based on a compared value.

12. The method of claim 9, wherein the comparing of the intensity of the detected current with the threshold comprises:
quantizing the detected current; and
comparing the quantized current with the threshold.

13. The method of claim 9, wherein the solar light generator is installed such that the solar light generator is exposed to the outside of the electronic apparatus, and is installed adjacent to an element that uses light from the backlight unit.

14. The method of claim 13, wherein the element which uses the light from the backlight unit comprises at least one of a Liquid Crystal Display (LCD) and a keypad.

15. The method of claim 9, wherein the backlight unit comprises at least one of a Cold Cathode Fluorescent Lamp (CCFL), an External Electrode Fluorescent Lamp (EEFL), a Light Emitting Diode (LED), and a Flat Fluorescent Lamp (FFL).

16. An apparatus for controlling brightness of a backlight unit in an electronic apparatus having a solar light generator, the apparatus comprising:
means for detecting a current generated by the solar light generator according to an amount of external light incident to the apparatus;
means for comparing an intensity of the detected current with a threshold; and
means for controlling the brightness of the backlight unit based on the compared value.

17. The apparatus of claim 16, wherein when an intensity of the current is less than a threshold, the brightness of the backlight unit is increased, and when the intensity of the current is greater than the threshold, the brightness of the backlight unit is decreased.

18. The apparatus of claim 17, wherein a degree of the increasing or the decreasing of the brightness of the backlight unit is subdivided based on a compared value.
